(19) United States
(12) Patent Application Publication
(10) Pub. No.: US 2010/0137029 A1
(43) Pub. Date: Jun. 3, 2010

(54) MULTI-STANDBY TERMINAL AND METHOD FOR REPRODUCING MOBILE BROADCASTING THEREOF

(75) Inventor: Chi Ho KIM, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/628,346

(22) Filed: Dec. 1, 2009

(30) Foreign Application Priority Data
Dec. 2, 2008 (KR) 10-2008-0121109

(51) Int. Cl. H04H 20/71; H04B 7/216; H04B 1/38

(52) U.S. Cl. 455/558; 370/335; 370/312

(57) ABSTRACT

A mobile broadcast reproducing method and a multi-standby terminal permit a terminal to receive broadcasts from different broadcast networks having different standards and even different broadcasting frequencies. The multi-standby terminal communicates with a variety of communication networks preferably includes a plurality of authentication processors and reproduces broadcast signals according to a variety of broadcast communication standards using the authentication processors. The terminal can also compare the a received signal strength indication (RSSI) of different networks and permit the user the option of selecting one of them based on this comparison, or can automatically select the broadcast having stronger RSSI signal.

### CLAIM OF PRIORITY

This application claims the benefit of priority under 35 U.S.C. §119 from a Korean patent application filed in the Korean Intellectual Property Office on Dec. 2, 2008 and assigned Serial No. 10-2008-0121109, the entire disclosure of which is hereby incorporated by reference in its entirety.

### BACKGROUND OF THE INVENTION

1. Field of the Invention

The present invention relates to portable terminals having a broadcasting function. More particularly, the present invention relates to a method that receives and reproduces a plurality of mobile broadcasts whose broadcast communication standards differ from each other, and a multi-standby terminal adapted to operate in accordance with the method.

2. Description of the Related Art

In recent years, portable terminals have included a variety of options, such as an MP3 player, a mobile broadcast reception function, a moving image reproduction function, a camera, etc. In particular, the mobile broadcast reception function allows portable terminals to provide a broadcasting service during movement. To improve interoperability, a variety of broadcasting standards have been developed in the mobile broadcast communication area. Examples of such broadcasting standards are a digital video broadcasting-handheld (DVB-H), a mediaFLO, a multi-media broadcasting multi-casting service (MBMS), etc.

Although such a variety of broadcast communication standards have been developed, their standardization has not yet been completed. Service providers have recently started providing a mobile broadcasting service using the broadcast communication standards.

Conventional portable terminals having a mobile broadcast reception function can reproduce broadcast signals according to only a single broadcast communication standard. Therefore, if the conventional portable terminals move from their original broadcasting service area to areas where broadcasting services having different broadcast communication standards are provided, such conventional portable terminals cannot reproduce broadcasts in these visited areas. In order to receive broadcasts in a visited area, users must use portable terminals that can reproduce broadcast signals according to the broadcast communication standard of the visited area. It is not uncommon for one to rent a portable terminal when on a business trip, for example. However, renting a portable terminal is inconvenient, costly, and potentially comprises the privacy of communication information in the rented phone, such as personal telephone numbers of colleagues, family, text message data, etc.

### SUMMARY OF THE INVENTION

The present invention provides a method that receives and reproduces a plurality of mobile broadcasts whose broadcast communication standards differ from each other, and a multi-standby terminal adapted to the method.

In accordance with an exemplary embodiment of the present invention, the present invention provides a method for reproducing mobile broadcasts in a multi-standby terminal, including: receiving a first broadcast signal according to a first broadcast communication standard; reproducing the first broadcast signal using a first authentication processor; comparing a received signal strength indication (RSSI) of a second broadcast signal with an RSSI of the first broadcast signal, if the second broadcast signal according to a second broadcast communication standard is received during the reproduction of the first broadcast signal; and reproducing the second broadcast signal using a second authentication processor if an RSSI of the second broadcast signal is greater than an RSSI of the first broadcast signal.

In accordance with another exemplary embodiment of the present invention, the present invention provides a multi-standby terminal including: a first broadcast receiver for receiving a first broadcast signal according to a first broadcast communication standard; a second broadcast receiver for receiving a second broadcast signal according to a second broadcast communication standard; a storage unit for storing a first authentication processor for reproducing the first broadcast signal and a second authentication processor for reproducing the second broadcast signal; and a controller for comparing a received signal strength indication (RSSI) of the second broadcast signal with an RSSI of the first broadcast signal if a broadcast reception function is activated, and reproducing one of the first and second broadcast signals whose RSSI is greater than that of the other signal.

### BRIEF DESCRIPTION OF THE DRAWINGS

The above and other illustrative aspects, features and advantages of certain exemplary embodiments of the present invention will become more apparent from the following description taken in conjunction with the accompanying drawing, in which:

FIG. 1 is a view illustrating a broadcast communication system according to an exemplary embodiment of the present invention;

FIG. 2 is a view illustrating a schematic block diagram illustrating a multi-standby terminal according to an exemplary embodiment of the present invention; and

FIG. 3 is a flow chart describing a method for reproducing broadcasts in a multi-standby terminal according to an exemplary embodiment of the present invention.

### DETAILED DESCRIPTION

Hereinafter, exemplary embodiments of the present invention are described in detail with reference to the accompanying drawings. Detailed descriptions of well-known functions and structures incorporated herein may be omitted to avoid obscuring appreciation of the subject matter of the present invention by a person of ordinary skill in the art.

Prior to discussing certain exemplary embodiments of the present invention, terminologies will be defined as used in the present description herein below. The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the exemplary embodiments disclosed in the description and configurations illustrated in the drawings are only preferred exemplary embodiments, and there are various modifications, alterations, and equivalents thereof that lie within the sprit of the invention and the scope of the appended claims.

In the following description, the term ‘authentication key’ refers to a way to identify a right to receive broadcast signals provide by a broadcasting service provider. In an exemplary embodiment of the present invention, the authentication key is stored in a subscriber identity module (SIM) card.

The term ‘authentication processor’ refers to a program that processes and reproduces received broadcast signals according to a broadcast communication standard. The authentication processor may require an authentication key to reproduce a broadcast signal that is set as a reception restriction function.

The term ‘subscriber identity module (SIM)’ refers to a commonly called card that stores subscriber identification information through which users can enjoy a variety of services, such as a subscriber authentication, billing, security function, etc. It should be understood that the present invention may also be implemented with a universal SIM (USIM), or other types of modules that would include such identification, authentication and authorization information, just to name a few items.

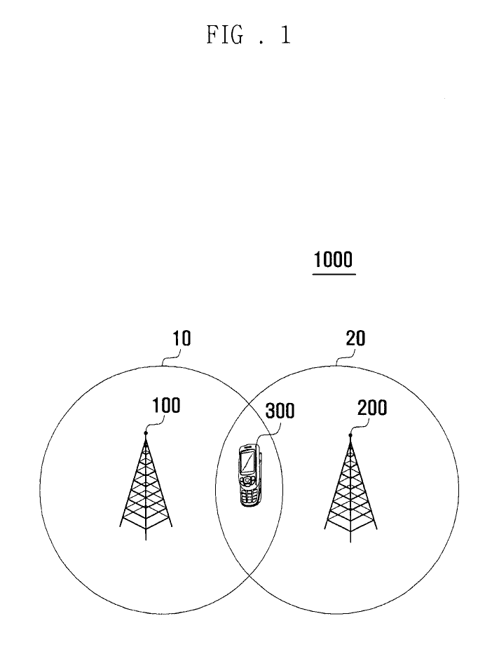

FIG. 1 is a view illustrating a broadcast communication system according to an exemplary embodiment of the present invention.

Referring now to FIG. 1, the broadcast communication system 1000 preferably includes a first broadcast communication network 100, a second broadcast communication network 200, and a multi-standby terminal 300.

The first broadcast communication network 100 provides a broadcasting service using one of a plurality of broadcast communication standards. For example, the first network 100 transmits a first broadcast signal according to a first broadcast communication standard to a first broadcasting service area 10. In an exemplary embodiment of the present invention, the broadcasting standard may be implemented by one of the digital video broadcasting-handheld (DVB-H), mediaFLO, and multi-media broadcasting multi-casting service (MBMS), etc.

The second broadcast communication network 200 provides a broadcasting service using a broadcast communication standard that differs from that of the first broadcast communication network 100. For example, the second network 200 transmits a second broadcast signal according to a second broadcast communication standard to a second broadcasting service area 20. The first broadcast communication standard and the second broadcast communication standard utilize different communication protocols by which the respective first broadcast signal and second broadcast signal are broadcast.

The multi-standby terminal 300 receives and reproduces the broadcast signals from both the first and second broadcast networks. To this end, it includes a plurality of broadcasting authentication processors. For example, the multi-standby terminal 300 may include a first authentication processor for reproducing the first broadcast signals transmitted from the first broadcast communication network 100, and a second authentication processor for reproducing the second broadcast signals transmitted from the second broadcast communication network 200. It is within the spirit and scope of the present invention that one processor could logically function as two logical authentication processors. In an exemplary embodiment of the present invention, the first and second authentication processors may be implemented with a Multimedia Broadcasting Business Management System (MBBMS) and a BroadCast/MultiCast Service (BCMCS), respectively. It should be understood that the present invention is not limited to the exemplary embodiment discussed herein. For example, the first and second authentication processors can employ a variety of communication methods according to broadcast communication standards. The multi-standby terminal according to the present invention can be achieved by combining the first authentication processor with the second authentication processor.

If the multi-standby terminal 300 is located in the first broadcasting service area 10, it reproduces the first broadcast signal using the first authentication processor. If the multi-standby terminal 300 moves to the second broadcasting service area 20, said multi-standby terminal 300 can reproduce the second broadcast signal using the second authentication processor. The first and second authentication processors can be implemented with a middleware and stored in the multi-standby terminal 300.

If the multi-standby terminal 300 is located in an area where the first and second service areas 10 and 20 overlap, the multi-standby terminal 300 compares received signal strength indications (RSSIs) of transmitted broadcast signals from the first and second broadcast communication networks 100 and 200, and reproduces a received broadcast signal whose RSSI is greater than the other signal. The multi-standby terminal 300 may display a selection window through which a user can select a broadcast to be reproduced. On the contrary, if the multi-standby terminal 300 does not receive both the first and second broadcast signals, the multi-standby terminal 300 displays a message indicating that receiving the broadcast is impossible.

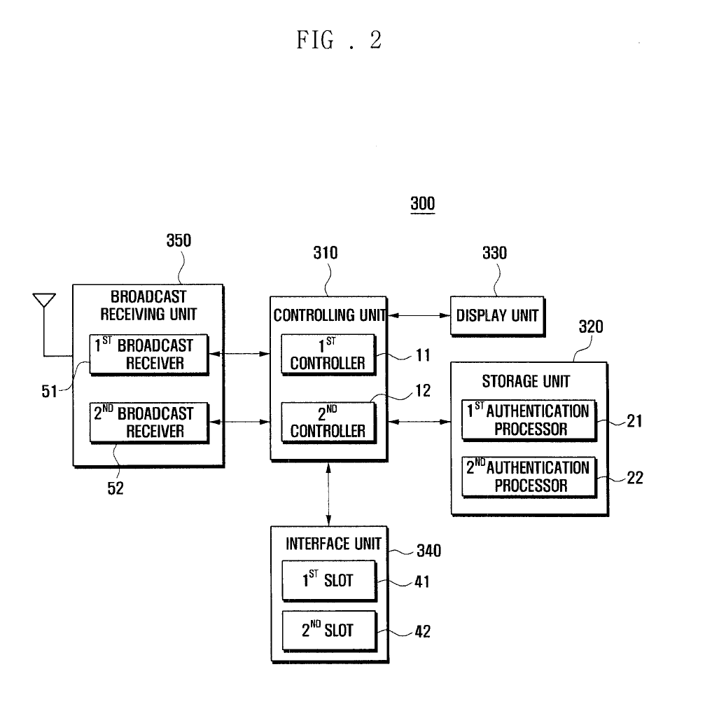

A description has been provided regarding the broadcast communication according to an exemplary embodiment of the present invention. In the following description, a configuration of the multi-standby terminal is explained in detail with reference to FIG. 2.

FIG. 2 is a view illustrating a schematic block diagram illustrating a multi-standby terminal according to an exemplary embodiment of the present invention.

Referring now to FIG. 2, the multi-standby terminal 300 includes a broadcast receiving unit 350, a display unit 330, a storage unit 320, an interface unit 340, and a controlling unit 310.

The display unit 330 displays a variety of menu screens for the multi-standby terminal 300, user's input data, function setting information, etc., and a variety of information to be provided to a user. If the display unit 330 is implemented with a touch screen, the display unit 330 can also serve as an input device. The display unit 330 may be implemented with a liquid crystal display (LCD), an organic light emitting diode (OLED), etc. In an exemplary embodiment of the present invention, if the multi-standby terminal 300 simultaneously receives a plurality of broadcast signals whose broadcast communication standards differ from each other, for example, first and second broadcast signals from first and second communication networks 100 and 200 (such as shown in FIG. 1), the display unit 330 preferably displays a selection window under the control of the controlling unit 310, so that a user can select one of the received first and second broadcast signals through the selection widow. If the multi-standby terminal 300 does not receive both the first and second broadcast signals, the display unit 330 displays a message indicating that impossible to receive a broadcast, under the control of the controlling unit 310. A person of ordinary skill in the art should understand that the present invention is not limited to a user selection at the time of reception and may have a default based on items such as, for example, signal strength, or if a particular message is identified as an emergency message.

The broadcast receiving unit 350 serves to receive broadcast signals. It may also receive broadcast signals whose broadcast communication standards differ from each other. To this end, the broadcast receiving unit 350 includes first and second broadcast receivers 51 and 52 for receiving first and second broadcast signals according to first and second broadcast communication standards, respectively. While one antenna is shown in FIG. 2, it is within the spirit of the invention that each receiver can have a separate antenna, particularly if there are different frequency bands received.

In an exemplary embodiment of the present invention, although the broadcast receiving unit 350 is implemented to include two broadcast receivers 51 and 52, it should be understood that the present invention is not limited to the exemplary embodiment. For example, the embodiment may be modified to include three or more broadcast receivers to receive three or more broadcast signals. If the broadcast receivers have the same modulation methods of the broadcast signals and the same frequency bands, the broadcast receiving unit 350 may receive a plurality of broadcast signals using one broadcast receiver.

The interface unit 340 refers to a device that receives subscriber identification module (SIM) cards. It may include first and second slots 41 and 42. For example, the first slot 41 receives a first SIM card, and the second slot 42 receives a second SIM card. The first SIM card may comprise a mobile communication SIM card employing a Time-Division Synchronous Code Division Multiple Access (TD-SCDMA). Similarly, the second SIM card may comprise a mobile communication SIM card employing a Code Division Multiple Access (CDMA). In an exemplary embodiment of the present invention, the first SIM card may store a first authentication key to identify a right to receive the first broadcast signal. Similarly, the second SIM card may store a second authentication key to identify a right to receive the second broadcast signal.

As described above, although the exemplary embodiment is implemented in such a way that the first and second SIM cards store the first and second authentication keys, respectively, it should be understood that the present invention is not limited to the embodiment. For example, the first and second authentication keys may be stored in the storage unit of the multi-standby terminal 300 or in a server of a broadcast service provider, according to authentication methods required by the broadcast service provider.

The storage unit 320 stores application programs required to operate the multi-standby terminal 300. For example, it stores an operation system (OS) for booting the multi-standby terminal 300, an application program for processing a message service, and application programs for reproducing audio, images, moving images, and mobile broadcast signals. The storage unit 320 also stores data generated as the multi-standby terminal 300 is used, moving image data, audio data, contents, etc. In an embodiment of the present invention, the storage unit 320 includes first and second authentication processors 21 and 22 for reproducing first and second broadcast signals according to first and second broadcast communication standards, respectively. The first and second authentication processors 21 and 22 may comprise Open Mobile Alliance-BroadCASting (OMA-BCAST), Conditional Access System (CAS), Multimedia Broadcasting Business Management System (MBBMS), Broad-Casting Multi-Casting Service (BCMCS), etc. In an exemplary embodiment of the present invention, the first authentication processor 21 comprises MBBS and the second authentication processor 22 comprises MCMCS. These first and second authentication processors 21 and 22 can be implemented with a middleware and stored in the storage unit 320.

Although the exemplary embodiment of the present invention is implemented in such a way that the storage unit 320 stores two authentication processors, a person or ordinary skill in the art should be understand that the present invention is not limited to the exemplary embodiments shown and described herein. For example, the storage unit 320 can store various types and amounts of authentication processors according to the specification of the multi-standby terminal and the request of service providers. There also may be more than one storage unit, and certain items dedicated to being stored in a particular unit. The first authentication processor 21 and the second authentication processor 22 may be realized in machine readable code, software or IC (Integrated Circuit) chip according to authentication method.

The controlling unit 310 controls the entire operation of the multi-standby terminal 300 and signal flows among the elements therein. The controlling unit 310 may be configured to include first and second controllers 11 and 12. The first controller 11 or the second controller 12 may serve as a primary controller. In that case, the other serves as a sub controller.

If the broadcast receiving unit 350 receives both the first and second broadcast signals according to the first and second broadcast communication standards, respectively, the controlling unit 310 compares RSSIs of the received first and second broadcast signals. According to the comparison result, the controlling unit 310 can reproduce the received broadcast signals that have a comparatively higher RSSI. Alternatively, the controlling unit 310 may control the display unit 330 to display a selection window so that the user can select one of the first and second broadcast signals therethrough. On the contrary, if the broadcast receiving unit 350 does not receive the first and second broadcast signals, the controlling unit 310 displays a message indicating that broadcast cannot be received on the display unit 330.

In addition, if the first or second broadcast signal is set to a receiving restriction function, such as a pay-per-view service or a viewing age restriction, the controlling unit 310 checks first and second authentication keys stored in the first and second SIM cards and identifies rights to receive the first and second broadcast signals, respectively.

Although not shown in the drawings, the multi-standby terminal 300 may further selectively include a camera module for capturing images or moving images, a short-range communication module for performing short-range wireless communication, an audio signal output unit such as a speaker, a voice signal input unit such as a microphone, a digital audio source reproducing module such as an MP3 module, etc. A person of ordinary skill in the art should understand and appreciate that the multi-standby terminal according to the presently claimed invention is not limited to include only the listed elements. With the convergence of digital devices, there are many digital devices and modifications thereof, not listed in the application, and, the artisan should certainly appreciate that such devices and modifications thereof can also be included in the multi-standby terminal 300.

The multi-standby terminal 300 having the elements described above may also reproduce a plurality of broadcast signals whose broadcast communication standards differ from each other. Therefore, although the multi-standby terminal 300 is moved from a first broadcasting service area to a second broadcasting service area where a broadcasting service is served with a broadcast communication standard that differs from that of the first broadcasting service area, the multi-standby terminal 300 can receive the second broadcasting service, which provides convenience to the user who is viewing broadcasts.

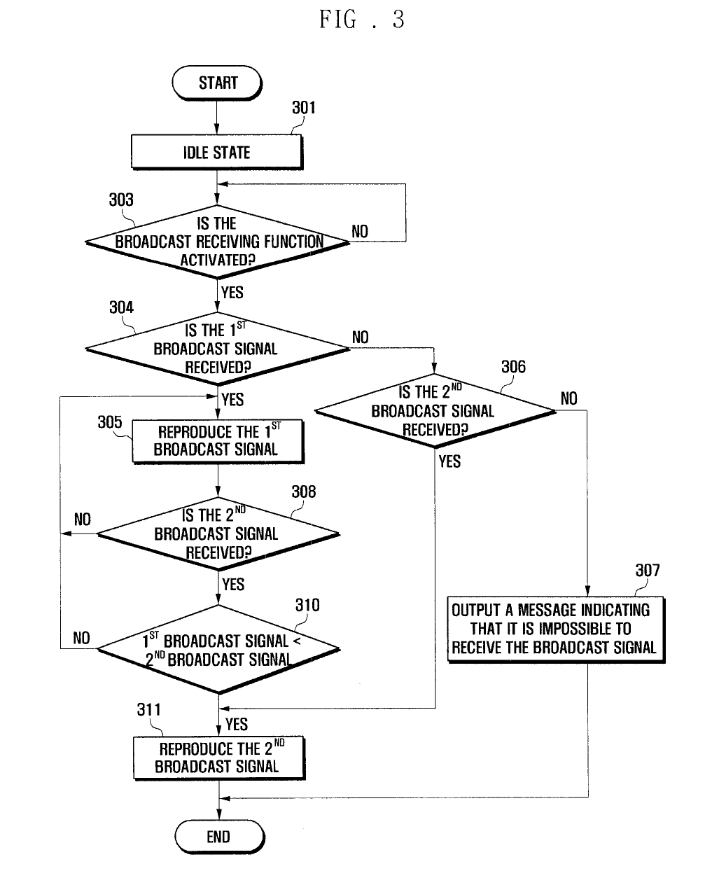

As described above, an explanation has been provided regarding the configuration and operation of the multi-standby terminal 300 according to an exemplary embodiment of the present invention. In the following description, a method is explained in detail that reproduces mobile broadcasts in the multi-standby terminal with reference to FIG. 3.

FIG. 3 is a flow chart describing a method for reproducing broadcasts in a multi-standby terminal according to an exemplary embodiment of the present invention.

For explanatory purposes, there is an assumption in this exemplary embodiment that the multi-standby terminal 300 location moves from a first broadcasting service area to a second broadcasting service area while the multi-standby terminal 300 is receiving a first broadcast signal in the first broadcasting service area.

Referring now to FIGS. 2 and 3, after the multi-standby terminal 300 is turned on, the controlling unit 310 allows the multi-standby terminal 300 to be operated in a standby/idle state (301). The controlling unit 310 detects whether or not a broadcast reception function has been activated (303). When the controlling unit 310 detects that a broadcast reception function has been activated (at 303), the controlling unit 310 then determines whether the multi-standby terminal 300 has received a first broadcast signal according to the first broadcast communication standard (304).

At step 304, if the controlling unit 310 ascertains that the multi-standby terminal 300 did not receive a first broadcast signal, the controlling unit 310 then determines whether the multi-standby terminal 300 has received a second broadcast signal according to the second broadcast communication standard (306). When the controlling unit 310 ascertains that the multi-standby terminal 300 has not received a second broadcast signal at 306, the controlling unit 310 controls the display unit 330 to display a message indicating that a broadcast cannot be received (307), and then terminates the procedure. On the contrary, when the controlling unit 310 ascertains that the multi-standby terminal receives a second broadcast signal at 306, the controlling unit 310 controls to reproduce the received second broadcast signal (311).

Meanwhile, if the controlling unit 310 ascertains that the multi-standby terminal receives a first broadcast signal at 304, the controlling unit reproduces the received first broadcast signal (305) in conjunction with other units, such as shown in FIG. 2. The controlling unit 310 may reproduce the first broadcast signal using a first authentication processor 21. In an exemplary embodiment of the present invention, the first authentication processor 21 may comprise a multi-media broadcasting business management system (MBBMS). The first authentication processor 21 can be implemented with a middleware.

During the reproduction of the first broadcast signal, the controlling unit 310 detects whether or not the multi-standby terminal 300 has received a second broadcast signal (308). If the controlling unit 310 ascertains that the multi-standby terminal 300 has received a second broadcast signal at 308, the controlling unit 310 compares an RSSI of the received second broadcast signal with that of the first broadcast signal (310).

If the controlling unit 310 ascertains that an RSSI of the received second broadcast signal is greater than the RSSI of the first broadcast signal at 310, the controlling unit 310 reproduces the second broadcast signal at 311. The controlling unit 310 may reproduce the second broadcast signal using a second authentication processor 22 that differs from the first authentication processor 21. In an exemplary embodiment of the present invention, the second authentication processor 22 may comprise a BroadCast/MultiCast Service (BCMCS). The second authentication processor 22 can be implemented with a middleware.

On the contrary, if the controlling unit 310 ascertains that an RSSI of the received second broadcast signal is equal to or less than that of the first broadcast signal at 310, the controlling unit 310 continues to reproduce the first broadcast signal at 305.

Although not explained in the foregoing description, if the first or second broadcast signal is set to a receiving restriction function, such as a pay-per-view service or a viewing age restriction, the controlling unit 310 can identify a right to receive the first or second broadcast signal. That is, the controlling unit 310 can check whether a first authentication key is stored in the first SIM card to identify the right to receive the first broadcast signal. Alternatively, the controlling unit 310 can check whether a second authentication key is stored in the second SIM card so as to identify the right to receive the second broadcast signal. The first SIM card may be implemented, for example, employing a Time-Division Synchronous Code Division Multiple Access (TD-SCDMA). The second SIM card may be implemented using a Code Division Multiple Access (CDMA), for example.

Although an exemplary embodiment of the present invention is implemented in such a way that first and second authentication keys are stored in SIM cards, the artisan should be understand that the present invention is not limited to the exemplary embodiments shown and described. For example, the first and second authentication keys may be stored, for example in the storage unit of the multi-standby terminal or in a server of a broadcast service provider.

In an exemplary embodiment of the present invention, although the SIM card may be implemented by a TD-SCDMA SIM card and a CDMA SIM card, the artisan should be understand that the present invention is not limited to the exemplary embodiments shown and described. That is, the SIM card may be implemented with a variety of interfaces.

Although the embodiment of the present invention is implemented in such a way that a determination is made as to whether the multi-standby terminal receives a second broadcast signal during the reproduction of the first broadcast signal, it should be understood that the present invention is not limited to the embodiment. The embodiment may be modified in such a way to determine whether the multi-standby terminal receives a first broadcast signal during the reproduction of the second broadcast signal.

As described herein above, the mobile broadcast reproducing method, according to the present invention, can reproduce a plurality of mobile broadcasts whose broadcast communication standards differ from each other in a multi-standby terminal, so that users can view broadcasts through a single multi-standby terminal adapted to the method. The mobile broadcast reproducing method and the multi-standby terminal adapted to the method can provide high quality broadcasts even in an area where a plurality of broadcast services overlap. In addition, the above-described methods according to the present invention can be realized in hardware, middleware, or as software or computer code that can be stored as machine readable code in a medium such as a ROM, an RAM, a floppy disk, a hard disk, or a magneto-optical disk or downloaded over a network, so that the methods described herein can be rendered in such software using a general purpose microprocessor, or a special processor or in programmable or dedicated hardware, such as an ASIC or FPGA.

As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although the invention has been shown and described with respect to certain exemplary embodiments thereof, the artisan should understand that these exemplary embodiments are only illustrative and not intended to limit the scope of the invention. Therefore, one skilled in the art will understand that the exemplary embodiments disclosed in the description and configurations illustrated in the drawings are only preferred exemplary embodiments, and there may be various modifications, alterations, and equivalents thereof, without departing from the scope and sprit of the invention as described in the accompanying claims.

What is claimed is:

1. A method for reproducing mobile broadcasts in a multi-standby terminal, comprising:
receiving a first broadcast signal according to a first broadcast communication standard;
reproducing the first broadcast signal using a first authentication processor;
comparing a received signal strength indication (RSSI) of a second broadcast signal with an RSSI of the first broadcast signal, if the second broadcast signal according to a second broadcast communication standard is received during the reproduction of the first broadcast signal; and
reproducing the second broadcast signal using a second authentication processor if an RSSI of the second broadcast signal is greater than an RSSI of the first broadcast signal.

2. The method according to claim 1, wherein the first broadcast communication standard and the second broadcast communication standard utilize different communication protocols by which the respective first broadcast signal and second broadcast signal are broadcast.

3. The method according to claim 1, wherein the first broadcast communication standard and the second broadcast communication standard are broadcast at different frequencies from each other.

4. The method of claim 1, wherein:
the first authentication processor comprises a multi-media broadcasting business management system (MBBMS); and
the second authentication processor comprises a BroadCast/MultiCast Service (BCMCS).

5. The method of claim 4, wherein the first and second authentication processors are implemented as a middleware.

6. The method of claim 1, further comprising:
displaying a message indicating that it is impossible to receive a broadcast if both the first and second broadcast signals are not received.

7. The method of claim 1, wherein:
reproducing the first broadcast signal comprises checking whether a first authentication key is stored in a first subscribe identity module (SIM) card to identify a right to receive the first broadcast signal; and
reproducing the second broadcast signal comprises checking whether a second authentication key is stored in a second subscribe identity module (SIM) card to identify a right to receive the second broadcast signal.

8. The method of claim 7, wherein:
the first SIM card employs a different communication protocol access than the second SIM card.

9. The method of claim 8, wherein:
the first SIM card employs a Time-Division Synchronous Code Division Multiple Access (TD-SCDMA); and
the second SIM card employs a Code Division Multiple Access (CDMA).

10. The method of claim 1, further comprising outputting a selection window through which a user can select a broadcast to be reproduced from one of the first and second broadcast signals.

11. A multi-standby terminal comprising:
a first broadcast receiver for receiving a first broadcast signal according to a first broadcast communication standard;
a second broadcast receiver for receiving a second broadcast signal according to a second broadcast communication standard;
a storage unit for storing a first authentication processor for reproducing the first broadcast signal and a second authentication processor for reproducing the second broadcast signal; and
a controller for comparing a received signal strength indication (RSSI) of the second broadcast signal with an RSSI of the first broadcast signal if a broadcast reception function is activated, and reproducing one of the first and second broadcast signals whose RSSI is greater than that of the other signal.

12. The multi-standby terminal of claim 11, wherein:
the first authentication processor comprises a multi-media broadcasting business management system (MBBMS); and
the second authentication processor comprises a BroadCast/MultiCast Service (BCMCS).

13. The multi-standby terminal of claim 12, wherein the first and second authentication processors are implemented as a middleware.

14. The multi-standby terminal of claim 11, wherein the controller displays a message indicating that it is impossible to receive a broadcast if the first and second broadcast signals are not received.

15. The multi-standby terminal of claim 11, further comprising an interface unit comprising:
a first slot for receiving a first subscribe identity module (SIM) card that stores a first authentication key to identify a right to receive the first broadcast signal; and
a second slot for receiving a second subscribe identity module (SIM) card that stores a second authentication key to identify a right to receive the second broadcast signal.

16. The multi-standby terminal of claim 15, wherein the first SIM card employs a different communication protocol access than the second SIM card.

17. The multi-standby terminal of claim 16, wherein:
the first SIM card employs a Time-Division Synchronous Code Division Multiple Access (TD-SCDMA); and
the second SIM card employs a Code Division Multiple Access (CDMA).

18. The multi-standby terminal of claim 12, wherein the first authentication processor and second authentication processor are respectively stored in the storage unit.
